(19) United States
(12) Patent Application Publication
(10) Pub. No.: US 2012/0181794 A1
(43) Pub. Date: Jul. 19, 2012

(54) MAGNETOELECTRIC COGENERATOR

(76) Inventors: FU-TZU HSU, Taipei City (TW); Chieh-Sen Tu, New Taipei City (TW)

(21) Appl. No.: 13/008,525

(22) Filed: Jan. 18, 2011

(51) Int. Cl. H02K 7/18; F03G 7/08; H02K 53/00

(52) U.S. Cl. 290/1 A; 74/DIG. 9

(57) ABSTRACT

A magnetoelectric cogenerator uses a magnetic fuel cell stack to convert renewable energy for outputting, and works basing on the first law of thermodynamics to covert potential into kinetic energy through the known Hall Effect and enables out-coupling of electric energy. For DC output, the magnetic fuel cell stack is an inductance-type high-frequency transformer; and for AC output, a DC permanent-magnet motor and a permanent-magnet self-excited generator enable forming of the cell stack, i.e. to combine with a power storage module to form the magnetoelectric cogenerator. A damper absorbs or eliminates anti-electromotive force (EMF) or eddy current from time to time for the DC permanent-magnet motor to always maintain in an optimal state for normal operation to reduce power consumption. The magnetoelectric cogenerator is able to stably generate power without producing any emission to thereby solve the problems of power supply and environmental protection in the electric energy application fields.

### FIELD OF THE INVENTION

The present invention relates to a magnetoelectric cogenerator using magnetic fuel cell stack to convert renewable energy and output DC or AC power, so that the generator can always maintain normal power generation operation that is also an autonomous power generation to thereby be a one hundred percent zero-emission green energy source.

### BACKGROUND OF THE INVENTION

A conventional renewable energy conversion generator is a charger connected to a public power supply and controlled by a timer to charge more than one battery. The power stored in the battery is supplied to a direct-current (DC) motor via control of a motor controller, so that the DC motor operates to drive an alternating-current (AC) generator. The power generated by the AC generator is distributed to loads via a power distribution panel. Taking a wind energy power generation system as an example, there is included an AC generator, the power generated by which belongs to cell instead of battery and could not be used as normal electric power. Further, taking the solar energy power generation system as an example, the power generated by which belongs to cell instead of battery and could not be used as normal electric power, either. The power generation efficiency of these systems is always a problem. To overcome this problem, there are two compromised solutions, one of which is to store the generated power in a battery for use as a backup power, and the other one of which is to directly use the generated power to drive a DC motor to reach a predetermined high rotational speed, so that the inertia acceleration of a counterweight flywheel rotating at high speed causes the DC motor to effortlessly and stably drive a permanent-magnet generator to operate and generate power (this type of generator is usually referred to as a flywheel generator or FWG). Therefore, the power generated from renewable energy can be stored as backup power during the off-peak hours, and the stored power is high-efficiently converted into the power supply required by loads during the on-peak hours. Generally speaking, the conventional backup power conversion and output unit is mainly characterized in that the backup power stored in the battery is controlled by the motor controller for outputting to the DC motor, and then, the large torque of the inertia in motion of the counterweight flywheel mounted on the output shaft of the DC motor is utilized to drive the permanent-magnet generator to generate electric power, which is then distributed via a power distribution panel to AC loads as the power supply thereof. Basically, in the whole backup power conversion process of the conventional power conversion and output unit, some of the power is consumed to maintain constant operation of the motor, and the backup power is not really converted and utilized in the most power-saving or the most efficient manner. In other words, the power stored in the battery can only be used as backup power instead of the normal power supply.

Further, the conditional factor for nonlinear control comes from the operation of the generator for generating power for use by loads. The higher the power generation is, the higher the load capacity of the motor is; and the lower the power generation is, the lower the load capacity of the motor is. Under this condition, when the generator works in the nonlinear operation mode, the generated electric energy is very unstable. This plus the frequent change in the potential at the loads would inevitably result in abnormal or overlarge surge in the power output circuit to adversely affect the stability of power output. In the event this type of surge is not buffered or eliminated, the generator tends to be subject to instantaneous overload and become burned out. Apparently, for the conventional backup power conversion and output unit to extend the best energy-saving effect, it is necessary to solve the problem of anti-electromotive force (EMF) or eddy current that is produced when the motor is nonlinearly controlled, and to buffer or eliminate the abnormal or overlarge surge in the nonlinear generator. Otherwise, the backup power conversion and output unit will only be a power conversion unit or even an energy-consuming unit.

### SUMMARY OF THE INVENTION

The present invention provides a magnetoelectric cogenerator using magnetic fuel cell stack to convert renewal energy and output DC or AC power. The generator uses a power storage module to convert AC power output from the cell stack into DC power for supplying to a load. The magnetoelectric cogenerator of the present invention can always maintain normal power generation operation that is also an autonomous power generation to thereby be a one hundred percent zero-emission green energy source.

The magnetoelectric cogenerator of the present invention includes a buffer battery unit, a power output load terminal, a potential to kinetic energy converting unit, a magnetic fuel cell stack forming unit, and a rectifying and charging unit. The buffer battery unit is a rechargeable battery that can be repeatedly charged and discharged for supplying power to the power output load terminal and the potential to kinetic energy converting unit. The potential to kinetic energy converting unit is able to produce electric resonance effect of oscillating eddy current to replace magnetic field shifting. The magnetic fuel cell stack forming unit includes a core wound around by a coil and permanent magnets that together with the core form a field loop. The eddy current produced by the potential to kinetic energy converting unit causes the magnetic fuel cell stack forming unit to produce high-frequency electric energy, which is amplified by a magnetic field effect of the permanent magnets to obtain the Hall Effect and form the cell stack. The rectifying and charging unit rectifies the cell stack formed by the magnetic fuel cell stack forming unit for charging the buffer battery unit and/or supplying power to the power output load terminal.

The magnetic fuel cell stack forming unit of the generator is configured basing on the first law of thermodynamics, and converts potential energy into kinetic energy via the known Hall Effect to enable out-coupling of electric energy at the same time.

In the case of a DC power output generator, the out-coupling of the electric energy is achieved by the magnetic fuel cell stack forming unit through a susceptance-type high-frequency transformer. And, in the case of an AC power output generator, a DC permanent-magnet motor and a permanent-magnet self-excited generator enable forming of the magnetic fuel cell stack, i.e. to combine with an electric power storage module to form the magnetoelectric cogenerator.

The magnetic fuel cell stack forming unit in the present invention has a potential to kinetic energy converting mechanism. The DC permanent-magnet motor of this converting mechanism must constantly work in a power-saving mode. In the operation of the present invention, a damper is utilized to eliminate the anti-electromotive force (EMF) and eddy current produced due to the use of a load to achieve the recycling and utilization of renewable electric power. This facilitates the stabilization of a nonlinear dynamic system, including dynamic power factor adjustment and dynamic adaptive damper as well as adaptive all-pass filter, all of which can be completely analyzed.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a system diagram of the present invention;

FIG. 2 is a structure diagram of an electric-resonance small-power magnetoelectric cogenerator according to a first embodiment of the present invention;

FIG. 3 is a structure diagram of an electric-resonance middle-to-large power magnetoelectric cogenerator according to a second embodiment of the present invention;

FIG. 4 shows a first type of core for the second embodiment of the present invention;

FIG. 5 shows a second type of core for the second embodiment of the present invention;

FIG. 6 is a structure diagram of a mechanical-resonance magnetoelectric cogenerator according to a third embodiment of the present invention; and

FIG. 7 is a structure diagram of a fourth embodiment of the present invention.

### DETAILED DESCRIPTION OF THE PREFERRED EMBODIMENTS

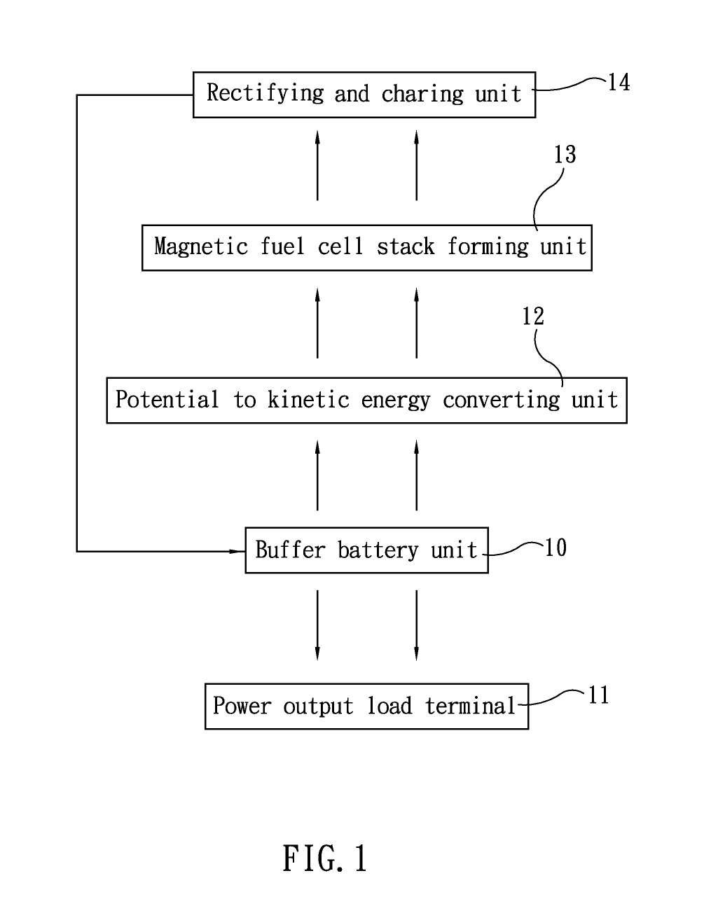

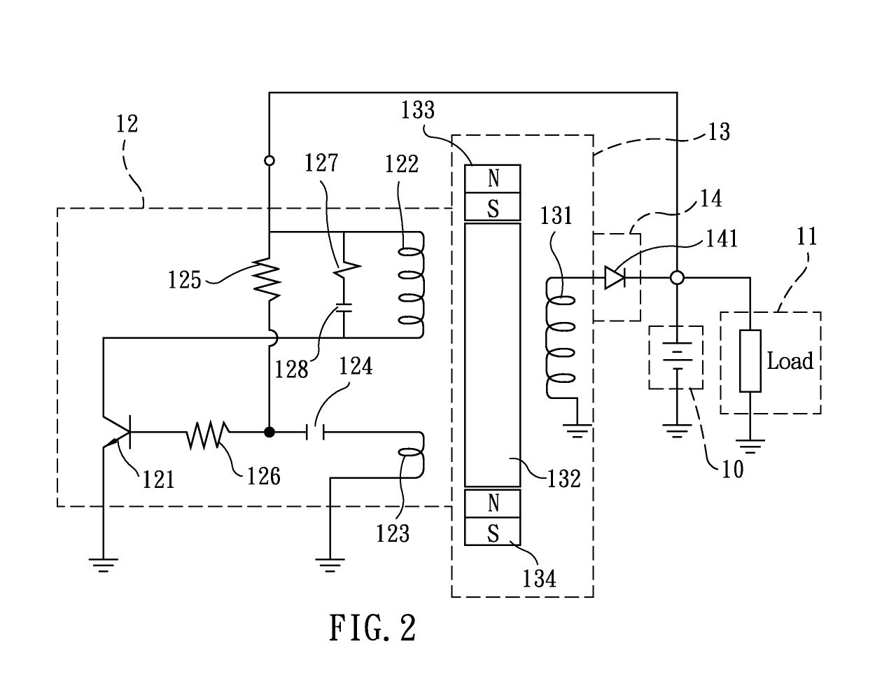

The present invention provides a magnetoelectric cogenerator using magnetic fuel cell stack to convert renewable energy for outputting. More particularly, the present invention provides a magnetoelectric cogenerator that uses Hall Effect as a basis and uses a mechanism of converting potential energy into kinetic energy to couple out electric energy. Please refer to FIG. 1. The magnetoelectric cogenerator of the present invention includes a buffer battery unit 10, a power output load terminal 11, a potential to kinetic energy converting unit 12, a magnetic fuel cell stack forming unit 13, and a rectifying and charging unit 14. The buffer battery unit 10 can be a battery unit of any type and is a rechargeable battery that can be repeatedly charged and discharged. The buffer battery unit 10 serves to supply electric power to the power output load terminal 11 and the potential to kinetic energy converting unit 12. The potential to kinetic energy converting unit 12 is featured by being capable of inputting discontinuous potential energy and outputting continuous kinetic energy. The potential to kinetic energy converting unit 12 is actuated by the electric power supplied from the buffer battery unit 10, and is able to produce an electrical resonance effect of oscillating eddy current in order to replace magnetic field shifting. Please also refer to FIG. 2, in which a structure diagram of a first embodiment of the present invention is shown. In the first embodiment, the magnetic fuel cell stack forming unit 13 includes a core 132 wound around by a coil 131 and permanent magnets 133, 134 that together with the core 132 form a magnetic field loop. The oscillating eddy current produced by the potential to kinetic energy converting unit 12 causes the magnetic fuel cell stack forming unit 13 to generate high-frequency electric energy, which is amplified by a magnetic field effect of the permanent magnets 133, 134 to obtain the Hall Effect and form a cell stack. The rectifying and charging unit 14 is capable of rectifying the cell stack formed by the magnetic fuel cell stack forming unit 13 for charging the buffer battery unit 10 and/or supplying power to the power output load terminal 11. The power output load terminal 11 is electrically connected to the buffer battery unit 10 to thereby form a power output terminal. Wherein, the electric energy out-coupled by the magnetic fuel cell stack forming unit 13 is converted by the rectifying and charging unit 14 from alternating current (AC) into direct current (DC) for storing in the buffer battery unit 10, or is filtered for use as a power supply to the power output load terminal 11.

The magnetoelectric cogenerator of the present invention has two types of power output, namely, AC output and DC output. The first embodiment illustrated in FIG. 2 is a DC output generator system. The potential to kinetic energy converting unit 12 can be an oscillating circuit unit triggered by a switching transistor 121. The oscillating circuit unit can be an integrated circuit (IC) oscillator or a switching controller. The potential to kinetic energy converting unit 12 includes switching controller induction coils 122, 123, a capacitor 124, resistors 125, 126, and a switching transistor 121. The potential to kinetic energy converting unit 12 is actuated by the power supply output from the buffer battery unit 10. When the potential to kinetic energy converting unit 12 as an oscillating circuit unit is triggered by the transistor 121, it is able to produce the electrical resonance effect of oscillating eddy current to replace magnetic field shifting.

The magnetoelectric fuel cell stack forming unit 13 is formed from a high-frequency transformer. Wherein, the core 132, the permanent magnets 133, 134, and the induction coil 131 together constitute a susceptance-type inductance unit to achieve electrical resonance and form the cell stack. The core 132 and the permanent magnets 133, 134 together form an open loop magnetic core. The rectifying and charging unit 14 is a high-frequency diode 141. The rectifying and charging unit 14 is able to convert AC into DC for storing in the rechargeable battery 10 to serve as a generator charger. The buffer battery unit 10 can supply power to the power output load terminal 11. In the generator system of the present invention, an anti-electromotive force (EMF) produced due to a load effect is dampened by an electrical damper 127 of a nonlinear resistor and a high-frequency capacitor 128, and then amplified by the permanent magnets 133, 134 to generate renewable electric power, so that the normal power generation operation is also autonomous power generation to thereby be a one hundred percent zero-emission green energy source.

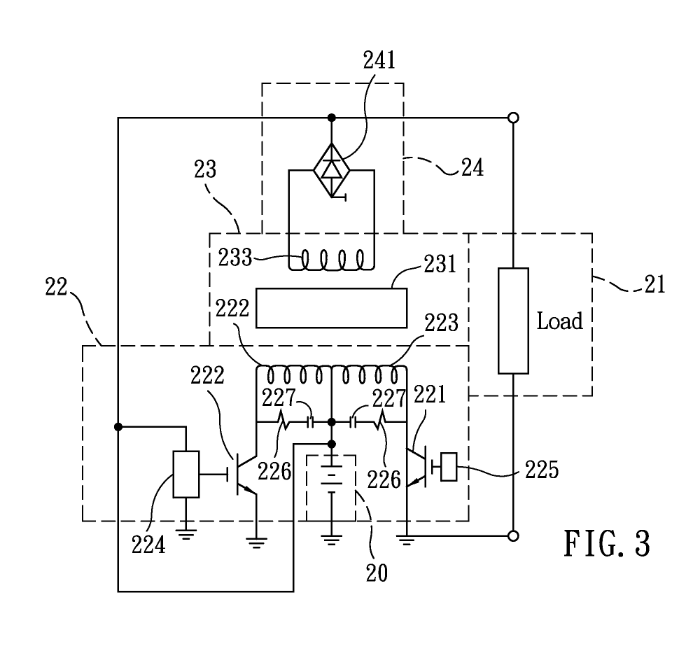

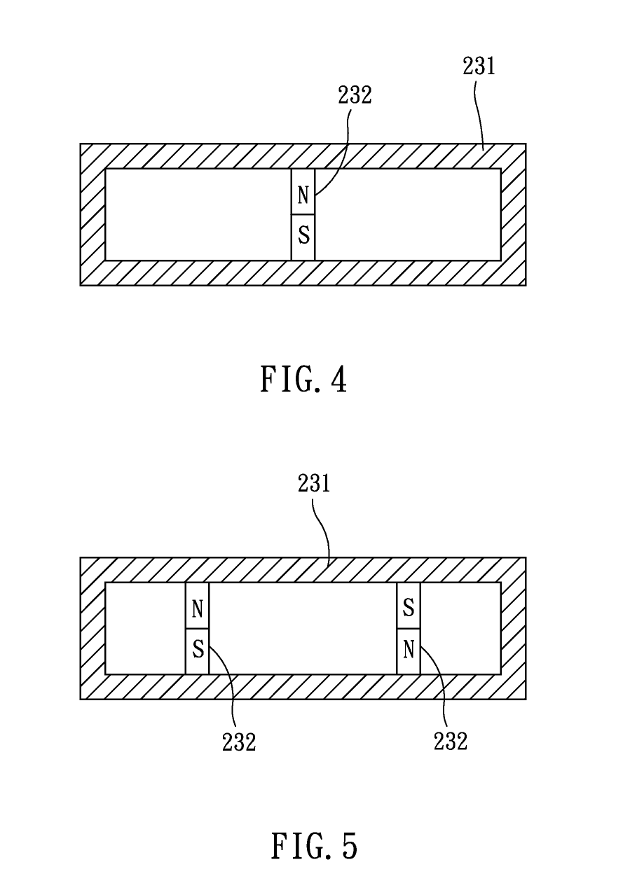

FIG. 3 shows a second embodiment of the present invention implemented as a DC-output high-power generator system. The generator in the second embodiment includes a buffer battery unit 20, a power output load terminal 21, a potential to kinetic energy converting unit 22, a magnetic fuel cell stack forming unit 23, and a rectifying and charging unit 24. The potential to kinetic energy converting unit 22 can be an oscillating circuit unit triggered by a switching transistor 221. The potential to kinetic energy converting unit 22 includes switching controller induction coils 222, 223, switching transistors 221, and self-excited oscillators 224, 225. Please also refer to FIG. 4. The magnetic fuel cell stack forming unit 23 is formed from a high-frequency transformer, which includes a core 231, permanent magnets 232, and an induction coil 233 to constitute a susceptance-type inductance unit to achieve electrical resonance and form the cell stack. The core 231 is a hollow core having at least one permanent magnet 232 disposed therein. And, in the case of having two or more permanent magnets 232 as shown in FIG. 5, the permanent magnets 232 are parallelly spaced in the hollow core 231 without contacting with one another and are so arranged that the N-poles and S-poles of any two adjacent permanent magnets 232 are always located diagonally opposite to one another, so as to form a closed loop. Wherein, the higher the number of permanent magnets 232 in the hollow core 231 is, the higher the power generation can be obtained. The rectifying and charging unit 24 can be a bridge rectifying charger 241. The cell stack formed by the magnetic fuel cell stack forming unit 23 can charge the rechargeable battery 20 via the bridge rectifying charger 241, or be filtered for outputting to the power output load terminal 21 as the power supply thereof. Wherein, an anti-electromotive force (EMF) produced due to a load effect is dampened by electrical dampers 226 of a nonlinear resistor and high-frequency capacitors 227, and then amplified by the permanent magnets 232 to generate renewable electric power.

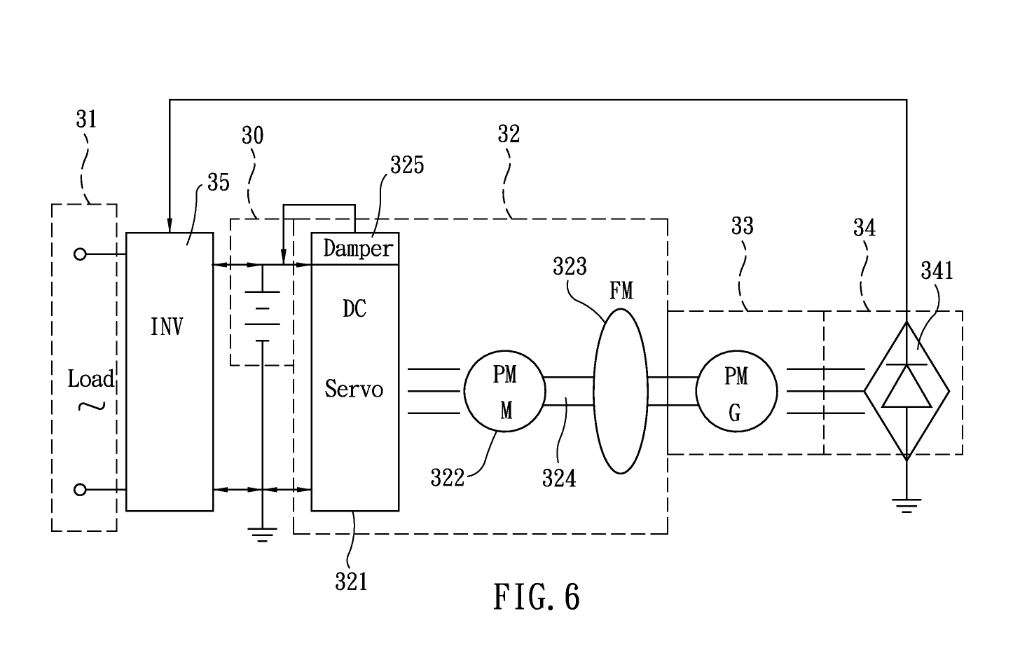

FIG. 6 shows a third embodiment of the present invention, which is implemented as a generator system that produces eddy current through mechanical resonance. The generator in the third embodiment includes a buffer battery unit 30, a power output load terminal 31, a potential to kinetic energy converting unit 32, and a rectifying and charging unit 34. The generator is a magnetoelectric cogenerator using magnetic fuel cell stack to convert renewable energy and outputting normal power supply. The power output can be AC output mode or DC output mode. Wherein, the buffer battery unit 30 is a rechargeable battery that can be repeatedly charged and discharged. The rectifying and charging unit 34 is a three-phase bridge charger 341 for charging the rechargeable battery 30. The potential to kinetic energy converting unit 32 includes a DC motor servo 321, a DC permanent-magnet motor 322, a flywheel 323, and a rotary shaft 324. The magnetic fuel cell stack forming unit 33 is provided on the rotary shaft 324. To achieve high-speed and stable cell stack output, it is necessary to provide a counterweight flywheel 323 in order to create mechanical resonance and produce eddy current for the magnetic fuel cell stack forming unit 33 to form the cell stack. Wherein, the provision of the flywheel 323 enables reduced power consumption by the DC permanent-magnet motor 322 and accordingly, increased output of electric power. The counterweight flywheel 323 can be otherwise a virtual flywheel hidden in the mechanism. For example, the magnetic fuel cell stack forming unit 33 can be configured to form a counterweight having the characteristic of a flywheel. The magnetic fuel cell stack forming unit 33 can have a core (not shown) structure like the open loop magnetic core 132 shown in FIG. 2, or the closed loop magnetic core 231 shown in FIGS. 4 and 5. When the three-phase bridge charger 341 charges too much cell stack output into the rechargeable battery 30, the DC motor servo 321 automatically reduces the rotational speed thereof, and vice versa, allowing the system shown in FIG. 6 to always maintain in a resonant state. The potential to kinetic energy converting unit 32 further includes an electrical damper 325. The electrical damper 325 enables the anti-electromotive force (EMF) and eddy current produced due to a load effect to be amplified by the permanent magnets to generate renewable electric power. That is, with the damper 325, the anti-electromotive force (EMF) and the eddy current produced during system operation are converted into renewable electric power. For example, by using a susceptance type unit, such as supper inductance, the anti-electromotive force (EMF) or the eddy current can be caused to return to the rechargeable battery 30, which would only absorb electric power without consuming electric power, so that more power can be saved at the input end. The power output at the power output load terminal 31 can be AC output or DC output. Wherein, an inverter 35 converts the electric power output from the rechargeable battery 30 into a type of power supply required by the power output load terminal 31. The power output load terminal 31 is mainly an isolation power transformer for adaptive impedance matching.

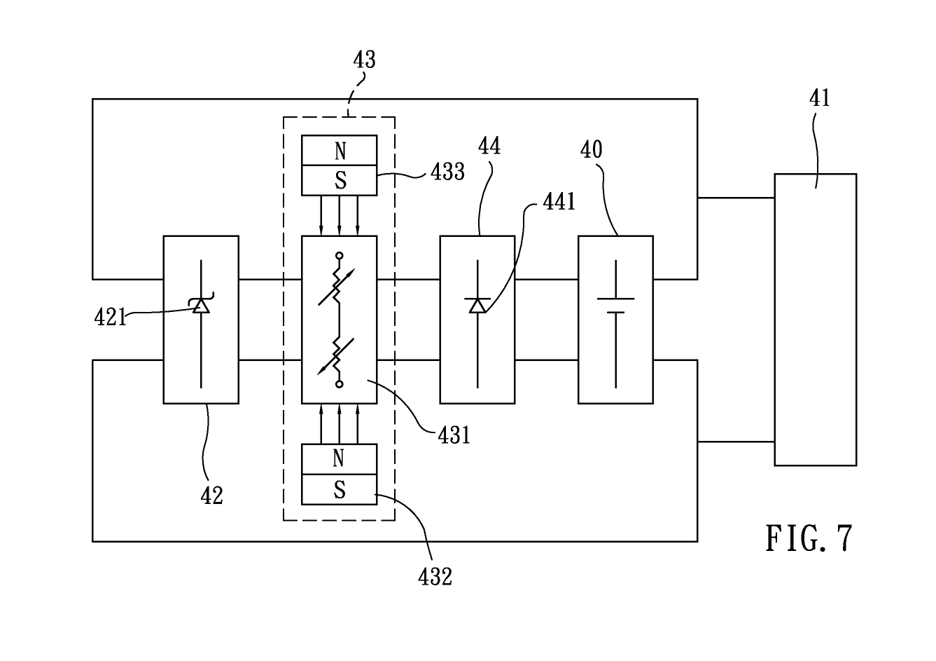

FIG. 7 shows a fourth embodiment of the present invention. The generator in the fourth embodiment includes a buffer battery unit 40, a power output load terminal 41, a potential to kinetic energy converting unit 42, a magnetic fuel cell stack forming unit 43, and a rectifying and charging unit 44. The buffer battery unit 40 is a rechargeable battery that can be repeated charged and discharged. The potential to kinetic energy converting unit 42 can be a Tunnel diode 421. The magnetic fuel cell stack forming unit 43 can be a static magnetic field created by a magnetro resistor 431 and permanent magnets 432, 433. The rectifying and charging unit 44 can be a fast diode or a Schottky barrier diode 441. The power output load terminal 41 can be a mobile device or a hand-held device. With the above arrangements, the generator of the present invention can achieve the function of a permanent stack battery.

In the present invention, a susceptance-type high-frequency transformer is used as a charger source for outputting DC power. Through the high-frequency transformer and the magnets 133, 134 (or 232, or 432, 433), electric energy is out-coupled and stored in the buffer battery unit 10 (or 20 or 40). Physically, the kinetic energy is orthogonal to amplitude, and the magnets 133, 134 (or 232, or 432, 433) determine the current gain. The magnetic fuel cell stack for AC output is formed by the DC permanent-magnet motor and the permanent-magnet self-excited generator. Since a self-excited generator requires kinetic energy, the kinetic energy physically has the same phase as that of amplitude and is orthogonal to frequency. In other words, the higher the rotational speed is, the more the electric energy can be output and accordingly, the more power can be saved at the input end. Wherein, the frequency must be stable. In the present invention, the inertia acceleration in motion of the counterweight flywheel 323 under high-speed rotation causes the DC permanent-magnet motor 322 to save power consumption and stably drive the permanent-magnet generator to operate and generate power. By utilizing the rotation of the DC permanent-magnet motor 322, kinetic energy is transferred to the counterweight flywheel 323 to form mechanical impedance matching and powerful torque is produced on the rotary shaft to thereby enable high kinetic energy output and effectively reduce the energy consumption by the DC permanent-magnet motor 322.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A magnetoelectric cogenerator using magnetic fuel cell stack to convert renewable energy for outputting, and particularly, using Hall Effect as a basis to convert potential energy into kinetic energy and out-couple electric energy, comprising:
a buffer battery unit being a rechargeable battery that can be repeatedly charged and discharged;
a power output load terminal being electrically connected to the buffer battery unit to serve as a power output terminal;
a potential to kinetic energy converting unit being actuated by power supply output from the buffer battery unit and being able to produce an electrical resonance effect of oscillating eddy current to replace magnetic field shifting;
a magnetic fuel cell stack forming unit including a core wound around by a coil, and permanent magnets that together with the core form a magnetic field loop; the oscillating eddy current produced by the potential to kinetic energy converting unit causing the magnetic fuel cell stack forming unit to generate high-frequency electric energy, which is amplified by a magnetic field effect of the permanent magnets to obtain the Hall Effect and form a cell stack; and
a rectifying and charging unit being capable of rectifying the cell stack formed by the magnetic fuel cell stack forming unit for charging the buffer battery unit and/or supplying power to the power output load terminal.

2. The magnetoelectric cogenerator as claimed in claim 1, wherein the potential to kinetic energy converting unit is a high-frequency transformer unit; the high-frequency transformer unit using an oscillating circuit unit to produce self-excited oscillation and thereby achieve electrical resonance for the magnetic fuel cell stack forming unit to obtain the Hall Effect and generating electric power.

3. The magnetoelectric cogenerator as claimed in claim 2, wherein the potential to kinetic energy converting unit is formed from a high-frequency transformer, and the high-frequency transformer constituting a susceptance-type inductance unit to achieve electrical resonance.

4. The magnetoelectric cogenerator as claimed in claim 2, wherein the potential to kinetic energy converting unit is an oscillating circuit unit triggered by a switching transistor.

5. The magnetoelectric cogenerator as claimed in claim 2, wherein the potential to kinetic energy converting unit is selected from the group consisting of an integrated circuit (IC) oscillator and a switching controller.

6. The magnetoelectric cogenerator as claimed in claim 2, wherein the potential to kinetic energy converting unit includes an electrical damper and high-frequency capacitors; the electrical damper and the high-frequency capacitors enabling an anti-electromotive force (EMF) and eddy current produced due to a load effect to be amplified by the permanent magnets to generate renewable electric power.

7. The magnetoelectric cogenerator as claimed in claim 1, wherein the magnetic fuel cell stack forming unit includes two permanent magnets, and the two permanent magnets being separately arranged at two opposite ends of the core to form an open loop.

8. The magnetoelectric cogenerator as claimed in claim 1, wherein the core of the magnetic fuel cell stack forming unit is a hollow core, in which at least one permanent magnet is arranged; and wherein the permanent magnets are parallelly spaced in the hollow core without contacting with one another to thereby form at least one closed loop.

9. The magnetoelectric cogenerator as claimed in claim 8, wherein any two adjacent ones of the permanent magnets in the core are so arranged that their N-poles and S-poles are always located diagonally opposite to one another, so as to form the closed loop.

10. The magnetoelectric cogenerator as claimed in claim 1, wherein the rectifying and charging unit is a high-power bridge rectifier.

11. The magnetoelectric cogenerator as claimed in claim 10, wherein the high-power bridge rectifier is a susceptance-type unit for absorbing and recycling an anti-electromotive force (EMF) and eddy current produced due to the use of a load device.

12. The magnetoelectric cogenerator as claimed in claim 1, wherein the potential to kinetic energy converting unit is a Tunnel diode; and the rectifying and charging unit is selected from the group consisting of a fast diode and a Schottky barrier diode.

13. A magnetoelectric cogenerator using magnetic fuel cell stack to convert renewable energy for outputting, and particularly, using Hall Effect as a basis to convert potential energy into kinetic energy and out-couple electric energy, comprising:
a buffer battery unit being a rechargeable battery that can be repeatedly charged and discharged;
a power output load terminal being electrically connected to the buffer battery unit to serve as a power output terminal;
a potential to kinetic energy converting unit being actuated by power supply output from the buffer battery unit and being able to produce a mechanical resonance effect to replace magnetic field shifting;
a magnetic fuel cell stack forming unit including a core wound around by a coil, and permanent magnets that together with the core form a magnetic field loop; the mechanical resonance effect produced by the potential to kinetic energy converting unit causing the magnetoelectric cogenerator to generate high-frequency electric energy, which is amplified by a magnetic field effect of the permanent magnets to obtain the Hall Effect and form a cell stack; and
a rectifying and charging unit being capable of rectifying the cell stack formed by the magnetic fuel cell stack forming unit for charging the buffer battery unit and/or supplying power to the power output load terminal.

14. The magnetoelectric cogenerator as claimed in claim 13, wherein the potential to kinetic energy converting unit is an inertia-spin flywheel unit; the inertia-spin flywheel unit including a DC permanent-magnet motor, an inertia flywheel, and a rotary shaft; and the magnetoelectric cogenerator being provided on the rotary shaft of the inertia-spin flywheel unit; whereby when the inertia-spin flywheel unit operates, a mechanical resonance effect is produced.

15. The magnetoelectric cogenerator as claimed in claim 14, wherein the magnetic fuel cell stack forming unit is provided on the rotary shaft of the inertia-spin flywheel unit; whereby when the inertia-spin flywheel unit operates, a resonance effect of oscillating eddy current is produced.

16. The magnetoelectric cogenerator as claimed in claim 14, wherein the flywheel of the inertia-spin flywheel unit is provided on the magnetic fuel cell stack forming unit on the rotary shaft.

17. The magnetoelectric cogenerator as claimed in claim 13, wherein the magnetic fuel cell stack forming unit has two permanent magnets, and the two permanent magnets being separately arranged at two opposite ends of the core to form an open loop.

18. The magnetoelectric cogenerator as claimed in claim 13, wherein the core of the magnetic fuel cell stack forming unit is a hollow core, in which at least one permanent magnet is arranged; and wherein the permanent magnets are parallelly spaced in the hollow core without contacting with one another to thereby form at least one closed loop.

19. The magnetoelectric cogenerator as claimed in claim 18, wherein any two adjacent ones of the permanent magnets in the core are so arranged that their N-poles and S-poles are always located diagonally opposite to one another, so as to form the closed loop.

20. The magnetoelectric cogenerator as claimed in claim 13, wherein the rectifying and charging unit is a high-power bridge rectifier.

21. The magnetoelectric cogenerator as claimed in claim 20, wherein the high-power bridge rectifier is a susceptance-type unit for absorbing and recycling an anti-electromotive force (EMF) and eddy current produced due to the use of a load device.

22. The magnetoelectric cogenerator as claimed in claim 13, wherein the potential to kinetic energy converting unit further includes a servo for controlling a rotational speed of the DC permanent-magnet motor to output DC power supply required by the power output load terminal.

23. The magnetoelectric cogenerator as claimed in claim 13, wherein the power output load terminal further includes an inverter for controlling a power of an isolation power transformer to output AC power supply required by the power output load terminal.

24. The magnetoelectric cogenerator as claimed in claim 13, wherein the potential to kinetic energy converting unit further includes an electric damper; the damper enabling an anti-electromotive force (EMF) and eddy current produced due to a load effect to be amplified by the permanent magnets to generate renewable electric power.
